(19) United States
(12) Patent Application Publication
(10) Pub. No.: US 2024/0324515 A1
(43) Pub. Date: Oct. 3, 2024

(54) Hedge Trimmer

(71) Applicant: YAMABIKO CORPORATION, Tokyo (JP)

(72) Inventors: Hisao KODAMA, Tokyo (JP); Takeshi MAENO, Tokyo (JP); Yusuke MORISAKI, Tokyo (JP); Yoshie NAKAJIMA, Tokyo (JP)

(21) Appl. No.: 18/605,994

(22) Filed: Mar. 15, 2024

(30) Foreign Application Priority Data
Mar. 29, 2023 (JP) 2023-054401

(51) Int. Cl. A01G 3/053; A01G 3/04

(52) U.S. Cl. CPC A01G 3/053; A01G 2003/0461

(57) ABSTRACT

A hedge trimmer comprises a cutter assembly and a drive operating portion for driving and operating the cutter assembly is provided. The drive operating portion in the hedge trimmer includes a body with a power source, a front handle, and a rear handle. The front handle includes a rod-shaped front gripping portion provided to protrude laterally of the cutter assembly and a trigger lever displaceably mounted on the front gripping portion, allowing and releasing transmission of drive power from the power source to the cutter assembly. When the hedge trimmer is viewed laterally in a state where a thickness direction of the cutter assembly being a vertical direction, the trigger lever is arranged to protrude from the front gripping portion in a direction inclined forward with respect to the vertical direction on a lower side of the vertical direction.

### CROSS REFERENCE TO RELATED APPLICATIONS

The present application claims priority under 35 U.S.C. § 119 to Japanese Patent Application No. 2023-054401, filed Mar. 29, 2023, the contents of which are incorporated herein by reference in their entirety.

### BACKGROUND

The present invention relates to a hedge trimmer.

### RELATED ART

A single-blade hedge trimmer designed for pruning hedges or shrubs is known (see JP 2021-58139 A).

The hedge trimmer includes a main body case, a blade (cutter assembly) extending forward from a front part of the main body case, a motor housed in the main body case and allowing the blade to drive, a support portion connected to the blade, a front grip (front gripping portion) connected to the support portion, and a rear grip (rear gripping portion) connected to the main body case behind the front grip. Then, a trigger lever is provided directly below the front grip in a state where the hedge trimmer is placed on a mounting surface.

With such a hedge trimmer, if a pruning point is far away, it is necessary to operate the trigger lever with an arm extended. In this case, a finger needs to be extended to reach the trigger lever directly below the front grip.

However, prolonged operation with the hedge trimmer under such a condition may lead to severe fatigue, causing the finger to unexpectedly leave the trigger lever and the blade to stop driving.

In view of the above circumstances, the present invention aims to provide a hedge trimmer that enhances operability.

According to an embodiment of the present invention, a hedge trimmer comprising a cutter assembly and a drive operating portion for driving and operating the cutter assembly is provided. The drive operating portion in the hedge trimmer includes a body with a power source, a front handle, and a rear handle. The front handle includes a rod-shaped front gripping portion provided to protrude laterally of the cutter assembly and a trigger lever displaceably mounted on the front gripping portion, allowing and releasing transmission of drive power from the power source to the cutter assembly. When the hedge trimmer is viewed laterally in a state where a thickness direction of the cutter assembly being a vertical direction, the trigger lever is arranged to protrude from the front gripping portion in a direction inclined forward to the vertical direction on a lower side of the vertical direction.

According to such an embodiment, the trigger lever is easy to operate even when an arm is extended, resulting in excellent operability.

### BRIEF DESCRIPTION OF THE DRAWINGS

FIG. 1 is an overall perspective view of a hedge trimmer as viewed from above.

FIG. 2 is a plan view of a hedge trimmer as viewed from below.

FIG. 3 is an enlarged perspective view showing a front handle.

FIG. 4 is a cross-sectional view taken along line A-A in FIG. 3.

### DETAILED DESCRIPTION

Hereinafter, an embodiment of the present invention will be described with reference to drawings. Various features shown in the following embodiment may be combined with each other.

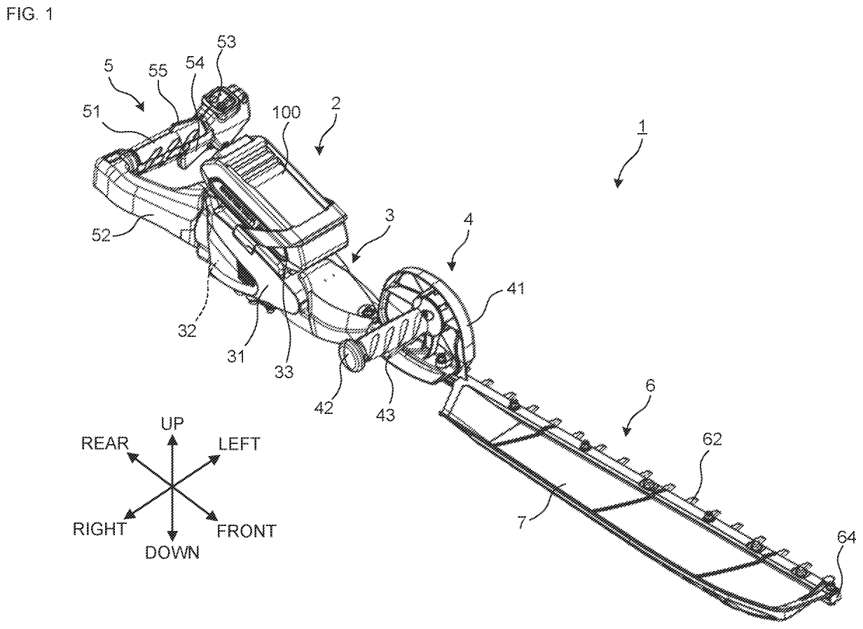

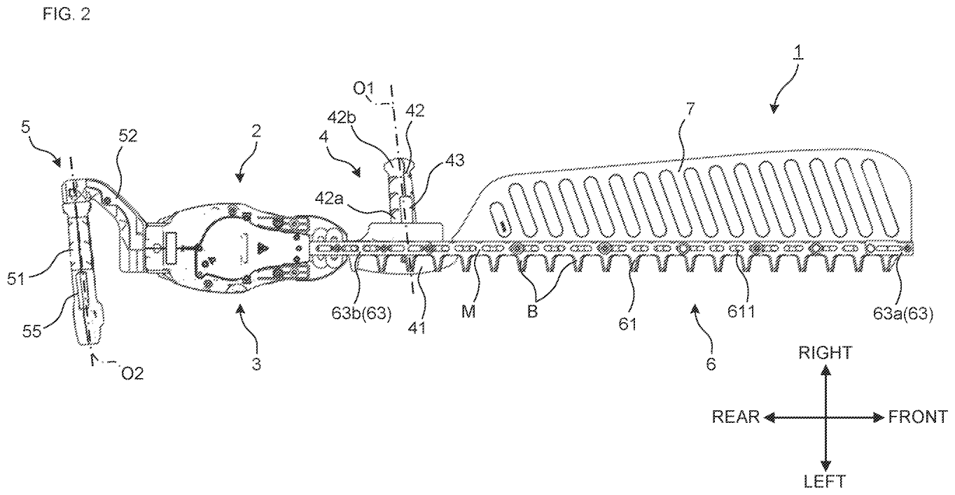

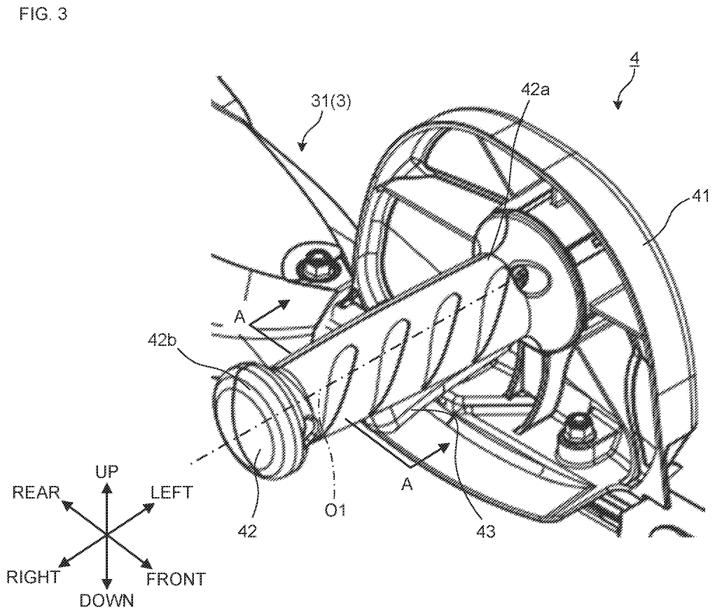

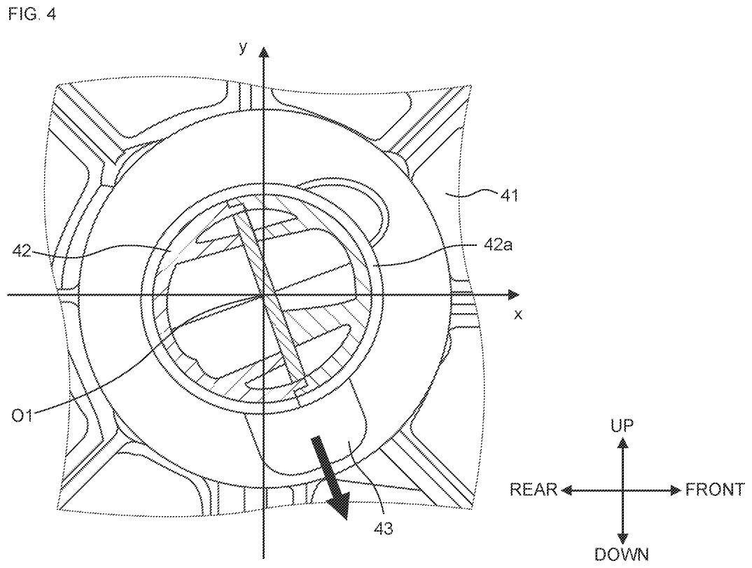

FIG. 1 is an overall perspective view of a hedge trimmer as viewed from above. FIG. 2 is a plan view of the hedge trimmer as viewed from below. FIG. 3 is an enlarged perspective view showing a front handle. FIG. 4 is a cross-sectional view taken along line A-A in FIG. 3.

Note that directions of the hedge trimmer and each component configuring the hedge trimmer are defined based on “up,” “down,” “left,” “right,” “front,” and “rear” shown in the drawings.

The hedge trimmer 1 shown in FIG. 1 is a hand-held compact cutting machine (driving apparatus) used for trimming or pruning hedges or shrubs, and is electrically driven with a battery 100 attached thereto.

The hedge trimmer 1 comprises a cutter assembly 6 and a drive operating portion 2 for driving and operating the cutter assembly.

The drive operating portion 2 includes a main body 3, a front handle 4, and a rear handle 5. The front handle 4 and the rear handle 5 may be grasped by a hand to operate the hedge trimmer 1.

In the present embodiment, an apparatus body is configured by the main body 3 and the cutter assembly 6. That is, the apparatus body has the cutter assembly 6 as a pruning portion for mowing or cutting an object.

On a front side of the main body 3, a cutter assembly 6 is provided, and on a right side of the cutter assembly 6, a receiving plate 7 is provided to receive the object that has been cut.

The cutter assembly (cutter assembly for hedge trimmer) 6 includes a lower cutter 61, an upper cutter 62, a lower cutter support 63 and an upper cutter support 64. The lower cutter 61 and the upper cutter 62 are superimposed on each other and are provided to be relatively slidable along a longitudinal direction (front-rear direction).

It should be noted that a configuration of the lower cutter 61 and a configuration of the upper cutter 62 are substantially identical.

The lower cutter support 63 is provided on a lower side of the lower cutter 61. From a viewpoint of weight reduction, the lower cutter support 63 is divided into two parts, a front support 63a and a rear support 63b, as shown in FIG. 2. In other words, the cutter assembly 6 has the lower cutter support 63 provided on a side of the lower cutter 61 opposite to the upper cutter 62, covering a part of the lower cutter 61.

On the other hand, the upper cutter support 64 is provided on an upper side of the upper cutter 62. Further, the upper cutter support 64 extends along the longitudinal direction (front-rear direction) of the cutter assembly 6.

Each of the lower cutter 61 and the upper cutter 62 has a cutter body M and two or more blade portions B protruding laterally from the cutter body M, as shown in FIG. 2. In the present embodiment, the cutter assembly 6 has a configuration where each of the lower cutter 61 and the upper cutter 62 is single-bladed, with two or more blade portions B protruding only on one side of the cutter body M.

A long hole 611 is formed in the cutter body M of the lower cutter 61, passing through the cutter body M in a thickness direction thereof and extending in a longitudinal direction. Further, a long hole is also formed in the cutter body M of the lower cutter 61, passing through the cutter body M in a thickness direction thereof and extending in a longitudinal direction (not shown). Forming such long holes allows for weight reduction for each of the lower cutter 61 and the upper cutter 62.

Each of the lower cutter 61 and the upper cutter 62 may have a double-edged configuration with two or more blades B protruding on both sides of the cutter body M.

The main body 3 includes a main body case 31 and an electric motor 32 housed in the main body case 31.

The main body case 31 is a resin-made box, and a top surface is inclined with respect to a bottom surface. The top surface of the main body case 31 inclines downward from a rear side to a front side. In other words, the main body case 31 is formed with a front part lower than a rear part. Thus, the main body case 31 is formed in an approximately triangular shape as viewed laterally.

The electric motor (power source) 32 is connected to the cutter assembly 6 through a drive transmission mechanism (not shown) and allows the cutter assembly 6 to drive. The cutter assembly 6 comprises the lower cutter 61 and the upper cutter 62, and the electric motor 32 allows the lower cutter 61 and the upper cutter 62 to relatively slide along a longitudinal direction.

On the top surface of the main body case 31, a battery mounting portion 33 is provided for mounting the battery 100. The battery mounting portion 33 is inclining downward from a rear part to a front part in accordance with the top surface of the main body case 31.

The battery 100 is a common battery with a rectangular case extending in a front-rear direction and housing two or more lithium-ion battery cells to achieve predetermined output.

Although not shown, at a rear end of a lower surface of the battery 100, there is an engagement portion protruding to engage with the battery mounting portion 33.

When mounting the battery 100 on the battery mounting portion 33, the lower part of the battery 100 is fitted into the battery mounting portion 33 while allowing the battery 100 to slide from rear to front with respect to the battery mounting portion 33. As a front end of the battery 100 is moved to a position supported by a front end of the battery mounting portion 33, the engagement portion of the battery 100 engages with the battery mounting portion 33 and the battery 100 is fixed to the battery mounting portion 33.

The battery 100 mounted on the battery mounting portion 33 is inclined to slope downward from a rear side to a front side, and a front part is arranged lower than a rear part.

On a top surface of the battery mounting portion 33, a metallic connection terminal (not shown) is provided. The connection terminal is electrically connected to a control board (not shown) or the electric motor 32. Then, by electrically connecting a connection terminal of the battery 100 to the connection terminal of the battery mounting portion 33, power is supplied from the battery 100 to the control board or the electric motor 32.

When removing the battery 100 from the battery mounting portion 33, operating a connecting lever (not shown) provided at a rear end of the battery 100 releases an engagement state between the battery mounting portion 33 and the engagement portion, which allows the battery 100 to slide rearward with respect to the battery mounting portion 33.

The front handle 4 is provided on a front side of the main body case 31 (main body 3), as shown in FIG. 1. The front handle 4 is provided between the main body 3 and the receiving plate 7.

The front handle 4 includes a plate-shaped support portion 41 arranged along an up-down direction, a rod-shaped front gripping portion 42 provided to protrude from the support portion 41 to a right side (a side of the cutter assembly 6), and a trigger lever 43 provided on a lower side of the front gripping portion 42. Then, the support portion 41 is fixed to the cutter assembly 6.

The trigger lever 43 has an elongated shape and is arranged in such a manner that a longitudinal direction thereof is along a central axis O1 of the front gripping portion 42, as shown in FIG. 2. Then, the trigger lever 43 is rotatably (displaceably) mounted on the front gripping portion 42 with a left side end as a rotational center.

Further, the rear handle 5 is provided at a rear side of the main body case 31 (main body 3). As shown in FIG. 1, the rear handle 5 includes a rod-shaped rear gripping portion 51 provided in a left-right direction (inclined along the longitudinal direction of the cutter assembly 6) and a connecting portion 52 connecting the rear gripping portion 51 and the main body 3. A power switch 53 is provided at a left end of the rear gripping portion 51.

Furthermore, on a lower side of the rear gripping portion 51, there is a throttle lever 54 provided as an operation means for allowing the cutter assembly 6 to drive, and on an upper side of the rear gripping portion 51, there is a lock release lever 55 provided to prevent and release a displacement (operation) of the throttle lever 54.

When an operator performs work on an object, by gripping the front gripping portion 42 and the rear gripping portion 51 of the hedge trimmer 1, holding the trigger lever 43 and the lock release lever 55, and operating the throttle lever 54 with a finger holding the rear gripping portion 51, the cutter assembly 6 may be allowed to drive.

Specifically, by gripping the trigger lever 43 while gripping the front gripping portion 42 and operating the throttle lever 54 provided on a lower side of the rear gripping portion 51, the battery 100 and the electric motor 32 are electrically connected to drive the electric motor 32. This allows a drive force from the electric motor 32 to be transmitted to the cutter assembly 6. On the other hand, by releasing the trigger lever 43, electrical connection between the battery 100 and the electric motor 32 is released and the electric motor 32 is stopped, thereby disabling transmission of the drive force from the electric motor 32 to the cutter assembly 6.

When the hedge trimmer 1 is viewed laterally in a state where a thickness direction of the cutter assembly 6 being a vertical direction (up-down direction), the trigger lever 43 is arranged to protrude from the front gripping portion 42 in a direction inclined to a front side with respect to the vertical direction. In other words, as shown in FIG. 4, when defining a plane coordinate with an axis along the longitudinal direction of the cutter assembly 6 as an x-axis and an axis orthogonal to the x-axis as a y-axis in such a manner that the central axis O1 of the front gripping portion 42 passes through an origin, the trigger lever 43 is arranged so as to protrude towards a fourth quadrant from the front gripping portion 42.

According to such a configuration, when a pruning point is far away, although it is necessary to grip the front gripping portion 42 with an arm extended and grip the trigger lever 43 with a finger, it becomes easier to reach the trigger lever 43 with a finger without performing a twisting motion of a wrist, such as wrapping the wrist towards a front side with respect to the front gripping portion 42. That is, this allows for improved operability of the trigger lever 43, thereby reducing fatigue for the operator.

An angle formed between a direction in which the trigger lever 43 protrudes (inclining towards the front side) and the vertical direction is preferably about 100 or more and 450 or less.

As mentioned above, the trigger lever 43 may be configured to electrically connect and disconnect (cut off) the battery 100 and the electric motor 32, as well as to activate and deactivate the drive transmission mechanism that transmits the drive power of the electric motor 32 to the cutter assembly 6.

As shown in FIG. 2, in a plan view of the hedge trimmer 1, the central axis O1 of the front gripping portion 42 is inclined with respect to the longitudinal direction of the cutter assembly 6 in such a manner that an outer (a side far from the cutter assembly 6) end 42b of the front gripping portion 42 is located on a rear side than on an inner (a side close to the cutter assembly 6) end 42a of the front gripping portion 42. This configuration eliminates the need for twisting the wrist when gripping the front gripping portion 42, thereby further reducing fatigue for the operator.

An angle between the central axis O1 of the front gripping portion 42 and the longitudinal direction of the cutter assembly 6 is preferably about 80° or more and 88° or less.

As shown in FIG. 2, in a plan view of the hedge trimmer 1, the central axis O1 of the front gripping portion 42 and a central axis O2 of the rear gripping portion 51 are arranged to be approximately parallel. With such a configuration, it becomes easier to enhance sense of unity of the operator with the hedge trimmer 1 during operation and reduce massive feeling when the operator lifts the hedge trimmer 1.

Further, as shown in FIG. 2, in a plan view of the hedge trimmer 1, the central axis O1 of the front gripping portion 42 is inclined towards the rear gripping portion 51 (rear side) with respect to the longitudinal direction of the cutter assembly 6, the central axis O2 of the rear gripping portion 51 is inclined towards the front gripping portion 42 (front side) with respect to the longitudinal direction of the cutter assembly 6, and the central axis O1 of the front gripping portion 42 and the central axis O2 of the rear gripping portion 51 are arranged to be approximately parallel. According to such a configuration, it becomes easier to reduce massive feeling when the operator lifts the hedge trimmer 1.

The hedge trimmer 1 as described above has excellent operability because the trigger lever 43 can be easily operated even with an arm extended.

It should be noted that instead of the electric motor 32, an engine may be applied as the power source for the hedge trimmer 1.

Further, the configuration of the trigger lever 43 is not limited to being rotatably mounted on the front gripping portion 42, any configuration may be sufficient as long as displaceably provided on the front gripping portion 42. For instance, a button may be retractably provided on the front gripping portion 42 in a direction perpendicular to the central axis O1 of the front gripping portion 42, or a slide lever may be slidably provided on the front gripping portion 42 in a direction along the central axis O1 of the front gripping portion 42.

Furthermore, each manner described below may be provided.

(1) A hedge trimmer comprising a cutter assembly and a drive operating portion for driving and operating the cutter assembly, wherein: the drive operating portion includes a body with a power source, a front handle, and a rear handle, the front handle includes a rod-shaped front gripping portion provided to protrude laterally of the cutter assembly and a trigger lever displaceably mounted on the front gripping portion, allowing and releasing transmission of drive power from the power source to the cutter assembly, and when the hedge trimmer is viewed laterally in a state where a thickness direction of the cutter assembly being a vertical direction, the trigger lever is arranged to protrude from the front gripping portion in a direction inclined forward with respect to the vertical direction on a lower side of the vertical direction.

(2) The hedge trimmer according to (1), wherein: the trigger lever has an elongated shape and is arranged in such a manner that a longitudinal direction thereof is along a central axis of the front gripping portion.

(3) The hedge trimmer according to (1) or (2), wherein: in a plan view of the hedge trimmer, the central axis of the front gripping portion is inclined with respect to a longitudinal direction of the cutter assembly in such a manner that an end of the front gripping portion on an opposite side of the cutter assembly is located on a rear side than an end of the front gripping portion on a side of the cutter assembly.

(4) The hedge trimmer according to (3), wherein: the rear handle includes a rob-shaped rear gripping portion provided so as to incline along a longitudinal direction of the cutter assembly, and in a plan view of the hedge trimmer, the central axis of the front gripping portion and a central axis of the rear gripping portion are arranged to be approximately parallel.

Of course, the present invention is not limited thereto.

Finally, although various embodiments of the present invention have been described, these are presented as examples and are not intended to limit the scope of the present invention. Other novel embodiments may be implemented in various forms, and various omissions, substitutions, and modification may be made within the scope of invention without departing from the spirit of the present invention. The embodiments or modifications thereof are included in the scope and spirit of the present invention, as well as within the scope of the invention and equivalents thereof recited in the claims.

What is claimed is:

1. A hedge trimmer comprising a cutter assembly and a drive operating portion for driving and operating the cutter assembly, wherein:
the drive operating portion includes a body with a power source, a front handle, and a rear handle,
the front handle includes a rod-shaped front gripping portion provided to protrude laterally of the cutter assembly and a trigger lever displaceably mounted on the front gripping portion, allowing and releasing transmission of drive power from the power source to the cutter assembly, and
when the hedge trimmer is viewed laterally in a state where a thickness direction of the cutter assembly being a vertical direction, the trigger lever is arranged to protrude from the front gripping portion in a direction inclined forward with respect to the vertical direction on a lower side of the vertical direction.

2. The hedge trimmer according to claim 1, wherein:
the trigger lever has an elongated shape and is arranged in such a manner that a longitudinal direction thereof is along a central axis of the front gripping portion.

3. The hedge trimmer according to claim 1, wherein:
in a plan view of the hedge trimmer, the central axis of the front gripping portion is inclined with respect to a longitudinal direction of the cutter assembly in such a manner that an end of the front gripping portion on an opposite side of the cutter assembly is located on a rear side than an end of the front gripping portion on a side of the cutter assembly.

4. The hedge trimmer according to claim 3, wherein:
the rear handle includes a rob-shaped rear gripping portion provided so as to incline along a longitudinal direction of the cutter assembly, and
in a plan view of the hedge trimmer, the central axis of the front gripping portion and a central axis of the rear gripping portion are arranged to be approximately parallel.
